(19) United States
(12) Patent Application Publication
(10) Pub. No.: US 2015/0181888 A1
(43) Pub. Date: Jul. 2, 2015

(54) Washing Machine Deodoizer

(71) Applicant: Weiman Products, LLC, Gurnee, IL (US)

(72) Inventors: Carl DeMasi, Lake Forest, IL (US); Sylwia Aldrin, Gurnee, IL (US)

(73) Assignee: Weiman Products, LLC, Gurnee, IL (US)

(21) Appl. No.: 14/144,010

(22) Filed: Dec. 30, 2013

(51) Int. Cl. A01N 63/00

(52) U.S. Cl. CPC A01N 63/00

(57) ABSTRACT

A method to control odors in an interior of a laundry washing machine by applying to surfaces of the interior of the washing machine a bacterial composition comprising bacterial spores capable of germinating into active bacteria which inhibit or prevent the production of at least one microorganism capable of causing odor.

### FIELD

The present application relates to a method of deodorizing the interior of washing machines.

### BACKGROUND

Odor can be an annoying problem in washing machines, particularly when small amounts of water are left behind creating bacteria breeding grounds or if rubber door seals are utilized which remain moist for a long time after use. Often, detergent manufacturers will use fragrances in their detergents, bleaches, stain removers, fabric softeners, and the like to mask the odor. There are also deodorizers containing bleaching agents designed specifically for use in washing machines to control odors. However, such deodorizers require running a separate wash cycle which is wasteful of water and electricity.

US. Publication 2012020766 teaches the addition of microorganisms to detergents or other liquids used in the wash cycles or applied to laundry intended to be washed. These microorganisms are intended to control the odor or prevent the odor from forming. Then, during the cycle of the washing machine, the microorganisms are distributed throughout the clothes and water. Water remaining behind in the machine after use may also contain some of the microorganisms.

It would be desirable to have a product that is applied separately and directly to the interior of the washing machine. Such a product would not be included in detergents or other liquids or solids used during the wash cycle of the machine or otherwise use the wash cycle for application thereof such as bleach deodorizers. Nor would the product need to be applied directly onto laundry to be run through the wash cycle.

### BRIEF SUMMARY

One aspect of the disclosure is directed to a method for controlling odors in an interior of a laundry washing machine, comprising within one hour after a wash cycle of the washing machine, applying to surfaces of the interior of the washing machine a bacterial composition comprising bacteria spores capable of germinating into active bacteria that prevent or reduce the growth of at least one microorganism capable of causing odor, wherein the bacteria remains active for at least 4 hours or until the next wash cycle.

In another aspect, the disclosure is directed to a method for controlling odors in an interior of a laundry washing machine, comprising: within one hour after completion of a wash cycle of the washing machine, removing any laundry from the washing machine, and applying to surfaces of the interior of the washing machine a bacterial composition comprising bacteria spores capable of germinating into active bacteria that consume soils on the interior surfaces prior to growth of at least one odor causing microorganism; wherein the active bacteria remain active at least until the soil is consumed.

In another aspect, the disclosure is directed to a method of deodorizing an interior of a laundry washing machine, comprising within one hour after completion of a wash cycle of the washing machine, applying to surfaces of the interior of the washing machine a bacterial composition comprising 1) bacteria spores capable of germinating into active bacteria that prevent or reduce the growth of at least one odor causing microorganism and 2) at least one odor absorber effective to eliminate or substantially reduce odors present on the surfaces after the wash cycle.

In another aspect, the disclosure is directed to a method of introducing a bacteria formula and washable materials to a washing environment, comprising:
(a) applying the bacteria formula to at least 80% of an exposed surface of a washing drum of a high-efficiency washing machine,
(b) applying the bacteria formula to at least 80% of an interior surface of a front door of the high-efficiency washing machine, and
(c) applying the bacteria formula to at least 80% of an exposed surface of a bellow positioned between the front door of the high-efficiency washing machine and the drum,

further comprising, without rinsing off the bacteria formula from the surfaces, placing the washable materials in the laundry machine,

wherein the applying of steps (a), (b), and (c) takes place through an atomizing sprayer,

wherein the applying of steps (a), (b), and (c) takes place less than 30 minutes after a laundry cycle has been completed in the high efficiency washing machine;

wherein the applying of steps (a), (b), and (c) takes place in any order, and

wherein the bacteria formula comprises a bacteria spores of the bacillus genus, a surfactant, a hydrotrope, an odor preservative, and a preservative.

### BRIEF DESCRIPTION OF THE DRAWINGS

FIG. 1 depicts a high efficiency front loading washing machine showing its interior.

FIG. 2 depicts a schematic of a portion of a high efficiency front loading washing machine showing its interior.

### DETAILED DESCRIPTION

The present disclosure is directed to a method of controlling undesirable odors in an interior of a laundry washing machine. Laundry for use in the laundry washing machine may be any washable materials that may be washed in a laundry machine including, but not limited to clothes, linens, towels, foot apparel, bedding, curtains, and the like. By controlling is meant preventing, reducing, or eliminating part or all of the odors. By undesirable odors is meant odors generally disagreeable to humans. Such odors include odors caused by at least one microorganism capable of causing such odors and may further include odors present at the end of the wash cycle from other sources.

Odors may be produced by a variety of bacterial sources such as described in US. Publication 2012020766 which recitations are hereby incorporated by reference. For example, a common and prolific bacterial species is Staphylococcus epidermidis. The particular types of odor causing bacteria spore present may depend on the region of the country, the types of soil or dirt present on the laundry, or the laundry soap or other products utilized.

The method comprises liberally applying to surfaces of the interior of the washing machine a bacterial composition comprising bacteria spores capable of germinating into active bacteria that prevent or reduce the production of undesirable odors caused by at least one microorganism capable of causing such odors. The bacterial spore germinates when applied to the surface and remains active until the next laundry cycle or at least for a time for the water in the bacterial composition and any residual water or moisture left behind by the wash cycle to evaporate. A cycle in the context of this application is a complete wash cycle including addition of water to the drum, addition of detergents, bleaches, and/or fabric softeners, agitation of the water, and removal of the water. The laundry is removed from the washing machine prior to application of the solution. The washing machine door can be closed after the application or can be kept open for 5-30 minutes or until the next wash cycle

Although not wishing to be bound by any theory, it is believed that odor causing microorganisms such as bacteria spores are present in air, residual water, detergent, and dirt that remain behind after a wash cycle, either on the interior surfaces of the machine or as a small puddle of water in the bottom of the drum or on bellows, seals, or gaskets. Bacteria from the spores begin to grow, utilizing the residual water, detergent, and dirt as food sources. As the bacteria consume and digest the food sources, such bacteria will emit odors. To avoid the emission of such odors, it is important to prevent the growth of the odor causing bacteria, and in order to prevent the growth of such bacteria, it is important to remove the food source. One way to remove the food source is to immediately run another wash cycle which flushes out such residual water, detergent, and dirt from the previous cycle. However, once this cycle is over, residual water, detergent, and dirt are again present.

It generally takes at least an hour or several hours for odor causing bacteria present as spores to germinate and grow in the food source. It was discovered that if competing bacteria spores are introduced onto the interior surfaces of the washing machine or onto remaining puddles of water immediately after a wash cycle, then the competing active bacteria will consume all or most of the food sources before odor causing bacteria from spores left behind in the washing machine can germinate. Eliminating the food source then eliminates or reduces the problem with odor causing bacteria.

It is important to apply the bacterial composition of competing bacterial spores into the interior of the washing machine as soon as possible after a wash cycle has ended. Suitable times include within one hour after a cycle ends, preferably, within 45 minutes, within 30 minutes, within 20 minutes, within 15 minutes, within 10 minutes, or within 5 minutes. The time to apply may depend in part of what type of odor causing bacteria is present and how long it takes to grow. The bacterial composition should be applied liberally to ensure that most or all interior surfaces are visibly wet.

The bacterial composition may be applied as a liquid solution, as a gel, or as foam.

The bacteria spores introduced by the bacterial composition germinate and remain effective or active until the next wash cycle, for example, for at least 6 hours, at least 8 hours, at least 12 hours, or at least 24 hours, for instance 8 to 12 hours or overnight.

Bacteria spores useful in the present invention as competing bacteria will generally not produce an undesirable odor or produce a less offensive or milder odor than the bacteria formed from the spores left behind in the wash cycle. Such bacteria strains are also described in US. Publication 2012020766 which recitations are hereby incorporated by reference.

The bacterial composition of the present invention may comprise bacterial spores from species of a Bacillus genus, for example, species selected from Bacillus subtilis, Bacillus amyloliquefaciens, Bacillus licheniformis, Bacillus megaterium, and/or Bacillus pumilus. In a particular example, the bacterial composition comprises bacterial spores from Bacillus megaterium. The bacterial spores are kept dormant by a preservative. Once the bacterial composition is applied to the surface and moisture as well as source of nutrients is available, the spores germinate into active bacteria.

The bacterial spores are generally present in the solution in an amount of 6E+08 to 8E+08 cfu/mL. The amount of bacterial spores is sufficient digest food sources (e.g. soil etc.) that can support growth of odor causing bacteria.

The bacterial composition may further comprise chelating agents, surfactants, hydrotopes, odor absorbers, preservatives, fragrances, acids, bases, thickening agents, neutralizers, and and/or foaming agents. The ingredients of the bacterial composition may be combined and then diluted with water.

For example, an odor absorber present in the bacterial composition will immediately absorb residual odors present from the wash cycle. Further, as noted above, the competing bacteria may produce some odor or the competing bacteria may not be 100% effective in eliminating the food source prior to the germination of the odor producing bacteria and there may be some minimal odor produced. The odor absorber removes these odors.

Chelating agents may be present in an amount of 0-1% by weight, 0.1-0.8% by weight, or 0.2-0.5% by weight by weight of the total bacterial composition to prevent hard water deposits. Suitable chelating agents include, but are not limited to, phosphates, phosphonates, citrates, iminodisuccinates, and salts of EDTA, GLDA, DTPA, HEDTA, EDG, PDTA, glucoheptonate, and methylglycinediaceticacid.

Surfactants may be present in an amount of 0-2% by weight, 0.1-1% by weight, or 0.2-0.5% by weight, based on the total weight of the bacterial composition to facilitate wetting of surfaces. Specific surfactants include, but not limited to, nonionic surfactants such as alcohol ethoxylates, alkanolamides, alkylamines, alkyl polyglucosides, ethylene oxide and propylene oxide copolymers; anionic surfactants such as alcohol sulfates, alkanesulfonates, alkylbenzenesulfonates, alkyl ether sulfates, and olefinsulfonates; and amphoteric surfactants such as amine oxides, betaines, imidazolines, sulfobetaines, and sultaines. Particular examples are ethoxylated alcohol (such as Tomadol 91-6), sodium lauryl sulfate (such as Stepanol WA), alkylpolyglucoside (such as Glucopon 425), and capryloamidopropyl betaine (such as Mackam OAB).

Hydrotopes may be present in an amount of 0-5% by weight, 0.5-4% by weight, or 1-3% by weight, based on the total weight of the bacterial composition to facilitate solubility of the components. Specific hydrotopes include but are not limited to sodium xylene sulfonate and sodium cumene sulfonate.

Odor absorbers may be present in an amount of 0-5% by weight, 0.5-4% by weight, or 1-3% by weight, based on the total weight of the bacterial composition to facilitate encapsulation of odors and to ensure odors will not become airborne. Specific odor absorbers include but are not limited to Ordenon (Bell Aire Fragrances) and Absorbzio (Sozio).

Preservatives may be present in an amount of 0-1% by weight, 0.05-0.5% by weight, or 0.1-0.2% by weight, based on the total weight of the bacterial composition to prevent microbial organisms from multiplying in the container. Specific preservatives include but are not limited to benzoic acid, benzoic acid derivatives, phenols, quaternary ammonium, DMDM hydantoin, methylchloroisothiazolinone, methylisothiazolinone, octylisothiazolinone, iodopropynyl butylcarbamate, benzisothiazolinone, and quaternium 15.

Acids or bases may be present as needed to adjust the pH to ensure optimal pH for the microorganisms. Typically, the pH of the solution is 5 to 10, particularly 7 to 8. Typically the acids or bases are included as salts in an amount of 0-5% by weight, 0.5-4% by weight, or 1-3% by weight, based on the total weight of the bacterial composition. Suitable salts include, but are not limited to, acetates, borates, bromides, carbonates, chlorides, citrates, hydroxides, iodides, nitrates, nitrites, phosphates, phosphonates, sulfates, sulfides, and sulfites.

Fragrances may be present in an amount of 0 to 1% by weight of the total bacterial composition to prevent bacteria from multiplying in the container. Specific fragrances include but are not limited to herbal fragrances.

Thickeners may be present in an amount of 0-2% by weight, or 0.05-0.8% by weight, or 0.1-0.3% by weight based on the total weight of the bacterial composition. One or more thickening agents can be used such as, but not limited to, acrylic acid based polymers, non-ionic polymers, surfactants (amphoteric, anionic, and non-ionic), and smectite clay. The viscosity may be 0-5000 cp, 50-3000 cp, or 100-1000 cp as measured by viscometer, at 25° C.

If needed, a neutralizer may be added with the thickener in an amount of 0-2% by weight, or 0.1-0.8% by weight, or 0.2-0.5% by weight based on the total weight of the bacterial composition. One or more neutralizers can be used such as, but not limited to monoethanolamine, diethanolamine, triethanolamine, monoisopropanolamine, diisopropanolamine, triisopropanolamine, morpholine, aminomethyl propanol), hydroxide (sodium hydroxide, potassium hydroxide, ammonium hydroxide), and sodium chloride.

Foaming agents may be added in an amount of 0-5% by weight, 0.1-4% by weight, or 0.5-1.0% by weight based on the total weight of the bacterial composition. One or more foaming agents can be used such as, but not limited to, alcohol sulfates, alkanesulfonates, alkylbenzenesulfonates, alkyl ether sulfates, amine oxides, betaines, and olefinsulfonates.

The bacterial composition may be prepared by mixing the various ingredients of the composition including the bacterial spores then diluted with water and mixed for at least 10 minutes, for example 10 to 60 minutes, typically 25 to 35 minutes, to form the bacterial composition such as a solution.

A liquid or spray bacterial composition may be added to a spray bottle, for example, for easy application to the interior surfaces of the washing machine. Generally, the ratio of the ingredients (other than water) to water is 5 to 20 parts ingredients to 80 to 95 parts water. The solution is then provided as a ready-to-use product. By spray bottle is meant any suitable spraying container

The water may be from any suitable source but is typically deionized water or other purified or sanitized water to avoid introduction of spores of odor causing bacteria or affecting stability of active ingredients.

Alternatively, the bacterial composition may be provided to the consumer in a concentrated form. If provided as a concentrate, the consumer may be directed to combine the bacterial composition with water to form a solution at the time of use.

The solution may be sprayed in any suitable manner. For example, the solution may be contained in a spray bottle for easy application by the user. The sprayer may be an atomizing sprayer that atomizes the solution into small particles or droplets, for example, droplet sizes of 30 to 100 microns.

The bacterial composition may also be applied as a gel by spraying interior surfaces with a gel bacterial composition using a spray bottle or by squeezing the gel bacterial composition onto the interior surfaces such as with a squeeze bottle. The squeeze bottle may have an applicator tip to spread the gel on surfaces.

The bacterial composition may also be applied as foam by spraying the bacterial composition from a spray bottle or by using an aerosol can where the foam forms on contact.

The application of the bacterial composition may occur following one or more washing cycles of said washing machine. For example, a load of laundry is subjected to a washing cycle and then removed from the washing machine. After removal, the bacterial composition is liberally applied to interior surfaces of the washing machine. The bacterial composition may be generously applied to ensure the desired surfaces are covered or saturated with the bacterial composition.

The bacterial composition may be applied to any portion of the interior of a washing machine, including the drum of the washing machine, any baffles attached to the drum, the interior side of the door or lid of the washing machine, rubber door seals (gaskets) and/or bellows In particular, the bellows and/or door gaskets or seals (which may be collectively one piece) are particularly vulnerable to bacteria growth and the bacterial composition should be applied thereto. Bellows and/or rubber seals can often be lifted or moved aside. If so, the bacterial composition may be applied underneath the bellows or seals as well. In addition, the bacterial composition may be applied to pull out drawers used for detergents, bleaches, and fabric softeners.

For instance, after the last load of laundry of the day, a generous amount of the solution is sprayed into the interior (including the drum, baffles, and bellows/rubber door seal) of the washer. The washer door can be closed after the application or left open. The product will start controlling odors immediately and will continue doing so until the next load of laundry. The product does not need to be rinsed after application and will not have any negative effect on the washer, laundry, or septic system.

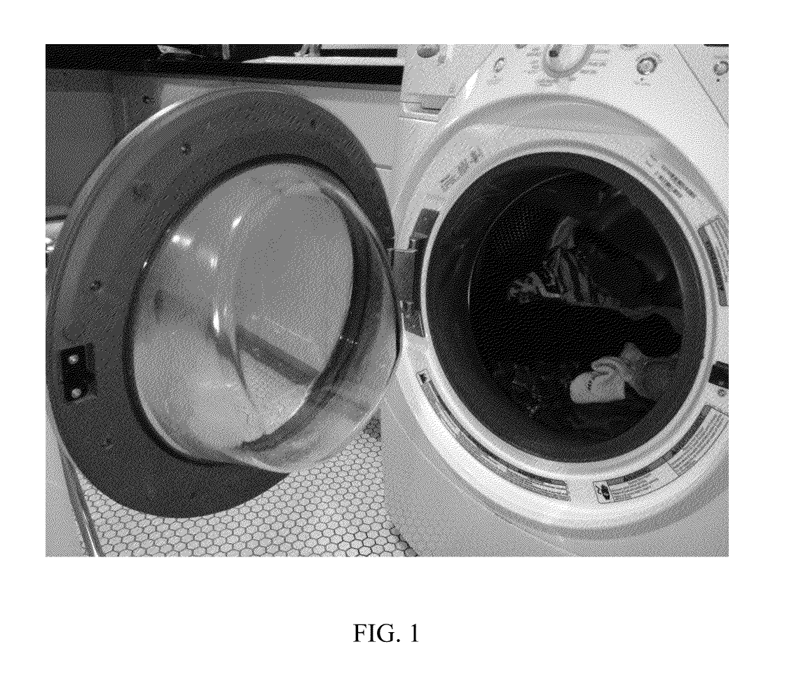

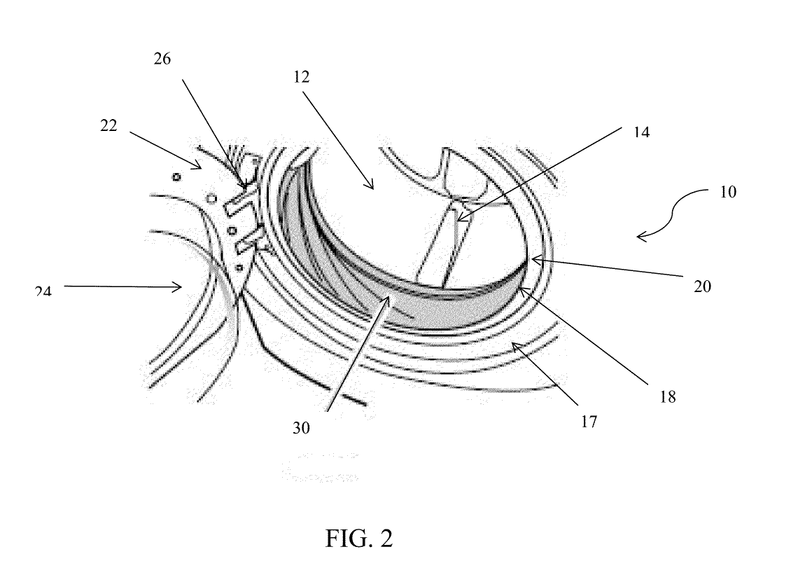

The washing machine may be a front load or top load machine. The bacterial composition is particularly useful for front loading high efficiency washing machines such as shown in FIG. 1 having the door opened and laundry contained therein. As shown in FIG. 2, generally a schematic of FIG. 1, a front loading high efficiency machine 10 has an interior drum 12 (also known as a basket or tub) typically with baffles 14 to help tumble the laundry therein. The machine further has a front 17 with a hole 18 for placement of the laundry into the interior of the machine. A bellow (also known as a gasket) 30 is positioned between the front edge of the hole 18 and the drum 12. This bellow may extend over the outside perimeter 20 of hole 18 to function as a gasket between the outside perimeter of the hole and the door, providing a seal to prevent leakage. Door 22 has a window 24 and may be attached to the machine 22 in any suitable manner such as a hinge 26. Additional gaskets (not shown) may be attached to the inner surface of the door or to the outer surface of the machine adjacent the hole so that when the door is closed, the gasket(s) provide additional seal(s). This is only one exemplification of a high efficiency washing machine. The present invention may work on any washing machine wherein odor control is desired.

In certain aspects, the bacterial composition is applied to at least 80%, at least 90%, or at least 95% of the exposed surface of a washing drum, at least 80%, at least 90%, or at least 95% of the interior surface of a front door of the washing machine, at least 80%, at least 90%, or at least 95% of the exposed surface of the gasket of the front door of the washing machine, and at least 80%, at least 90%, or at least 95% of the exposed surface of the gasket on the front surface of the washing machine.

The method of the present invention results in elimination or reduction of odor. The odor is reduced by at least 50%, at least 60% at least 70%, at least 80%, or at least 90%, and up to 100%. The reduction of odor may be analyzed subjectively by test subjects or by qualitatively analyzing microbes (bacteria) that grow in untreated and treated samples to determine the number of odor causing bacteria and the number of competing bacteria.

The method of the present invention results in preventing growth of at least 80%, at least 90%, at least 95%, at least 99%, or 100% of the odor causing bacteria.

The examples which follow are intended as an illustration of certain preferred embodiments of the invention, and no limitation of the invention is implied.

### EXAMPLE 1

| | Weight Percent |
|---|---|
| Ingredient | (w/w %) |
| Bacterial blend (Evogen Renew Plus 10X from Genesis | 12.0 |
| Biosciences or Freshen Free 10X from Novozymes) | |
| Fragrance | 0.2 |
| Water | 87.8 |

The blend was combined with the fragrance and water and mixed for 25 to 30 minutes to produce a solution. The solution was then applied to interior surfaces of a washing machine after a wash cycle. The results were analyzed subjectively by smell to see if odors were detected after application and prior to the next wash cycle. In a study performed over a four week period per use instructions, all participants thought that the product either eliminated or reduced malodor. The solution started to work immediately and kept odors in check for up to 3 days after application.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A method for controlling odors in an interior of a laundry washing machine, comprising:
within one hour after completion of a wash cycle of the washing machine, applying to a plurality of surfaces of the interior of the washing machine a bacterial composition comprising bacterial spores capable of germinating into active bacteria that prevent or reduce the production of at least one odor causing microorganism;
allowing the bacterial spores time to germinate into active bacteria, wherein the bacteria remain active for at least 4 hours.

2. The method of claim 1, wherein the bacterial spores comprise at least type selected from the group consisting of Bacillus subtilis, Bacillus amyloliquefaciens, Bacillus licheniformis, Bacillus megaterium, and Bacillus pumilus.

3. The method of claim 2, wherein the bacterial spores comprises Bacillus megaterium.

4. The method of claim 1, wherein the bacterial composition comprises from 6E+08 to 8E+08 cfu/mL of the bacterial spores.

5. The method of claim 1 wherein the bacterial composition further comprises at least one compound selected from the group consisting of chelating agents, a surfactants, hydrotopes, odor absorbers, preservatives, fragrances, acids, bases, thickeners, neutralizers, and foaming agents.

6. The method of claim 1 comprising applying the bacterial composition within 30 minutes of the wash cycle of the washing machine.

7. The method of claim 1 comprising applying the bacterial composition within 15 minutes of the wash cycle of the washing machine.

8. The method of claim 1 wherein the bacteria remain active for at least 12 hours after application to the plurality of interior surfaces.

9. The method of claim 1 wherein the bacteria remain active for at least 24 hours after application to the plurality of interior surfaces.

10. The method of claim 1 comprising applying the solution onto at least one surface of the plurality of surfaces wherein the at least one surface is a surface selected from the group of surfaces consisting of an interior surface of a drum of the washing machine, an interior side of a door of the washing machine, a bellow positioned between the drum and door, and gaskets or seals.

11. The method of claim 1 comprising applying the bacterial composition onto the interior of a drawer in the washing machine for dispensing detergents, bleach, or fabric softener.

12. The method of claim 1 wherein the washing machine is a front loading washing machine.

13. The method of claim 1 wherein the bacterial composition is a solution and the solution is applied by spraying.

14. A method for controlling odors in an interior of a laundry washing machine, comprising:
within one hour after completion of a wash cycle of the washing machine, removing any laundry from the washing machine, and applying to a plurality of surfaces of the interior of the washing machine a bacterial composition comprising bacterial spores capable of germinating into active bacteria that consume soils on the interior surfaces;
allowing the bacterial spores to germinate into active bacteria and consume the soils.

15. The method of claim 14 wherein the bacterial composition is a solution and the solution is applied by spraying.

16. The method of claim 15 further comprising spraying the solution onto stagnant water present in the interior of the washing machine.

17. A method for preventing or reducing the production of at least one odor causing microorganism in an interior of a laundry washing machine, comprising
within one hour after completion of a wash cycle of the washing machine, applying to surfaces of the interior of the washing machine a bacterial composition comprising
1) bacteria spores capable of germinating into active bacteria that prevent or reduce the production of at least one odor causing microorganism and
2) at least one odor absorber effective to eliminate or substantially reduce odors present on the surfaces after the wash cycle.

18. The method of claim 17 wherein the at least one odor absorber is further effective to eliminate or substantially reduce odors produced by the active bacteria.

19. The method of claim 17 wherein the bacterial spores comprise Bacillus megaterium.

20. The method of claim 17 wherein the bacterial composition is a solution and the solution is applied by spraying.

21. The method of claim 20 comprising spraying the solution onto at least one surface of the plurality of surfaces wherein the at least one surface is a surface selected from the group consisting of an interior surface of a drum of the washing machine, an interior side of a door of the washing machine, and a bellow positioned between the drum and the door.

22. A method of introducing a bacteria formula and washable materials to a washing environment, comprising:
(a) applying the bacteria formula to at least 80% of an exposed surface of a washing drum of a high-efficiency washing machine,
(b) applying the bacteria formula to at least 80% of an interior surface of a front door of the high-efficiency washing machine, and
(c) applying the bacteria formula to at least 80% of an exposed surface of a bellow positioned between the front door of the high-efficiency washing machine and the drum,
further comprising, without rinsing off the bacteria formula from the surfaces, placing the washable materials in the laundry machine,
wherein the applying of steps (a), (b), and (c) takes place through an atomizing sprayer,
wherein the applying of steps (a), (b), and (c) takes place less than 30 minutes after a laundry cycle has been completed in the high efficiency washing machine;
wherein the applying of steps (a), (b), and (c) takes place in any order, and
wherein the bacteria formula comprises a bacteria spores of the bacillus genus, a surfactant, a hydrotrope, an odor preservative, and a preservative.

23. The method of claim 22, wherein the washable materials comprise clothing.

24. The method of claim 22, wherein the bacteria of the bacillus genus comprises Bacillus megaterium.
